(19) United States
(12) Patent Application Publication
(10) Pub. No.: US 2026/0079741 A1
(43) Pub. Date: Mar. 19, 2026

(54) SYSTEMS AND METHODS FOR RESOLVING COMPLIANCE CHECKS AND UPDATES

(71) Applicant: The PNC Financial Services Group, Inc., Pittsburgh, PA (US)

(72) Inventors: Mark TROMBULAK, Pittsburgh, PA (US); Ricardo Marcelino LOPEZ REY, Pittsburgh, PA (US); Federico GUTIERREZ, Pittsburgh, PA (US)

(73) Assignee: The PNC Financial Services Group, Inc., Pittsburgh, PA (US)

(21) Appl. No.: 19/377,541

(22) Filed: Nov. 3, 2025

Related U.S. Application Data
(63) Continuation of application No. 18/680,745, filed on May 31, 2024.
(60) Provisional application No. 63/505,854, filed on Jun. 2, 2023.

(51) Int. Cl. G06F 9/455; G06F 8/30; G06F 8/61; G06F 8/65; G06F 11/3698; G06F 21/57

(52) U.S. Cl. CPC G06F 9/45558; G06F 8/30; G06F 8/63; G06F 8/65; G06F 11/3698; G06F 21/577; G06F 2009/45562; G06F 2221/033

(57) ABSTRACT

Disclosed herein are systems and methods for building and deploying containerized software services during software development. The disclosed embodiments involve accessing code from a code repository corresponding to a software service. The disclosed embodiments involve generating a template for the software service based on the code. The disclosed embodiments involve storing the template in a template repository and detecting a vulnerability in the code. In some embodiments, responsive to detecting the vulnerability in the code, the disclosed embodiments involve updating the code to mitigate the vulnerability, generating an updated template based on the updated code, deploying the updated template to a container orchestration platform, and generating an instance of the software service with the container orchestration platform based on the updated template.

### CROSS-REFERENCE TO RELATED APPLICATIONS

This continuation of U.S. patent application Ser. No. 18/680,745, filed May 31, 2024, which claims benefit of U.S. Provisional Application No. 63/505,854, titled “Systems and Methods for Resolving Compliance Checks and Updates,” filed Jun. 2, 2023, the contents of which are incorporated herein in their entirety.

### TECHNICAL FIELD

The present disclosure relates to systems and methods for addressing vulnerabilities by automatically resolving compliance checks and updates for software.

### BACKGROUND

Conventional methods and systems of managing software, including programs or applications offered by third party vendors, may involve version control to implement updates or changes. Repositories may contain code corresponding to different versions of software, including older and newer versions. Software versions in operation, such as on a system used by an individual or a company, may become outdated as newer versions of the software are released. It may be important to update or upgrade such software to mitigate vulnerabilities by implementing new features, bug fixes, or addressing security issues. Software versions not matching the most recently released version of the software may be deemed as not being in compliance, because such software may be vulnerable to viruses, malware, or crashes. Conventional systems and methods of managing compliance checks involve manually identifying whether new versions of software have been released, cloning code in the repository and updating the code in match the new versions and generating pull requests for each repository. Given that institutions may have thousands of repositories, traditional methods of deploying updated software may be inefficient, expensive, and resource-intensive.

Accordingly, there is a need for easier and more efficient ways to mitigate vulnerabilities, which may include easier ways for updating and deploying software that are more memory and computationally efficient.

The disclosed embodiments may enable faster deployment of software by reducing the amount of research or investigation for implementing similar compliance changes across software services (e.g., as compared to each development team for a software service researching the change on their own). As such, the disclosed embodiments provide cost savings by reducing developer hours spent on such tasks. In addition, by generating pull requests to repositories, the disclosed embodiments reduce the need for cloning repositories or feature branches to local machines, thereby conserving memory for computing devices. Further, the disclosed embodiments reduce code error for different implementations of the same code changes.

### SUMMARY

The systems and methods disclosed herein may be used in various applications and business systems. It is to be understood that the foregoing general description and the following detailed description are exemplary and explanatory only and are not restrictive of the disclosed embodiments.

The disclosed embodiments involve systems and methods for building and deploying containerized software services during software development. Some disclosed embodiments may involve accessing code from a code repository corresponding to a software service. Some disclosed embodiments may involve generating a template for the software service based on the code. Some disclosed embodiments may involve storing the template in a template repository. Some disclosed embodiments may involve detecting a vulnerability in the code. In some embodiments, responsive to detection of a vulnerability in the code, the disclosed embodiments may involve updating the code to mitigate the vulnerability, generating an updated template based on the updated code, deploying the updated template to a container orchestration platform, and generating an instance of the software service with the container orchestration platform based on the updated template.

According to a disclosed embodiment, the operations may further include storing the updated template in a deployment repository, the deployment repository comprising at least one configuration file, and deploying the updated template to the container orchestration platform based on the configuration file.

According to a disclosed embodiment, generating the template may include a continuous integration (CI) pipeline.

According to a disclosed embodiment, deploying the updated template may include a continuous deployment (CD) pipeline.

According to a disclosed embodiment, the container orchestration platform may include a development environment, a testing environment, and a production environment.

According to a disclosed embodiment, the code repository may include at least one configuration file having the code.

According to a disclosed embodiment, the operations may further include updating a base image based on updated code of the at least one configuration file and building the updated template based on the updated base image.

In some embodiments, a processor may be configured to automatically resolve compliance checks and updates. Some disclosed embodiments may include accessing compliance versions for a plurality of software services corresponding to a plurality of repositories, wherein a first repository in the plurality of repositories may have a current software service version and a target branch. Some disclosed embodiments may include determining whether the first repository corresponds to a periodic automation label or a standalone automation label. Some disclosed embodiments may include generating a plug-in based on the compliance versions, wherein the plug-in comprises update code. Some disclosed embodiments may include determining whether the first repository in the plurality of repositories is compliant by comparing the current software service version to the compliance version. Some disclosed embodiments may include responsive to the determination that the first repository is not compliant, generating a pull request for the target branch; wherein the pull request may include a modification to the first repository based on the update code.

According to a disclosed embodiment, the processor may further determine whether the first repository corresponds to a periodic automation label or a standalone automation label. And according to a disclosed embodiment, the processor may generate a ticket, wherein the generated ticket may include a periodic automation ticket based on the determination that the first repository corresponds to a periodic automation or the generated ticket may include a standalone automation ticket based on the determination that the first repository corresponds to a standalone automation.

Other systems, methods, and computer-readable media are also discussed herein. Disclosed embodiments may include any of the above aspects alone or in combination with one or more aspects, whether implemented as a method, by at least one processor, and/or stored as executable instructions on non-transitory computer readable media.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 presents an illustration of an exemplary system for resolving compliance checks, consistent with embodiments of the present disclosure.

FIG. 2 is an illustration of a system for deploying software to resolve vulnerabilities, consistent with embodiments of the present disclosure.

FIG. 3 presents an exemplary diagram of an electronic communication system, consistent with disclosed embodiments.

FIG. 4 illustrates a block diagram of a system for software management, consistent with embodiments of the present disclosure.

FIG. 5 illustrates a diagram of a containerized software service implementation, consistent with embodiments of the present disclosure.

FIG. 6 illustrates a block diagram of a process for building and deploying containerized software, consistent with embodiments of the present disclosure.

FIG. 7 illustrates a block diagram of a system for automatically resolving compliance checks and updates, consistent with embodiments of the present disclosure.

FIG. 8 illustrates a diagram of a plug-in for updating software services, consistent with embodiments of the present disclosure.

FIG. 9 illustrates a process for updating code with a plug-in, consistent with embodiments of the present disclosure.

FIG. 10 illustrates a process for automatically resolving compliance checks and updates, consistent with embodiments of the present disclosure.

FIG. 11 illustrates an exemplary deployment container structure, consistent with disclosed embodiments.

FIG. 12 illustrates a process for distributing configurations, consistent with embodiments of the present disclosure.

FIG. 13 illustrates a process for migrating repositories, consistent with embodiments of the present disclosure.

FIG. 14 illustrates a process for analyzing code, consistent with embodiments of the present disclosure.

FIG. 15 illustrates a process for automating command line interface commands, consistent with embodiments of the present disclosure.

FIG. 16 illustrates a process for chain of command repository reporting, consistent with embodiments of the present disclosure.

FIG. 17 illustrates a process for updating release branches, consistent with embodiments of the present disclosure.

FIG. 18 illustrates a process for building and deploying containerized software services during software development, consistent with embodiments of the present disclosure.

### DETAILED DESCRIPTION

Reference will now be made in detail to exemplary embodiments, discussed with reference to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, steps may be added or steps may be removed without departing from the envisioned embodiments. Thus, the materials, methods, and examples are illustrative only and are not intended to be necessarily limited.

It will be appreciated that the disclosed embodiments provide improvements to version management and mitigating vulnerabilities for software, including efficiency, speed, cost, and resource consumption improvements. Addressing software vulnerabilities and compliance issues can be a resource and time intensive task involving changes to software across different systems. For example, the same update or similar code changes may be distributed to various software services or to various repositories, which may be a resource and cost-intensive task for institutions having thousands of repositories. Conventional methods of addressing a vulnerability, such as in source code, configuration files, or a base image (e.g., for a Docker image), may involve different developers or systems, as the vulnerability may have to detected, reported, fixed, and shipped to a production environment.

Further, failure to mitigate or resolve vulnerabilities may result in increased exposure to malware or data breaches, as well as an increased chance of crashes or other service failures. In addition, for certain industries, maintaining complaint software may be a priority, including for industries which may handle sensitive data or be governed by various regulations. For example, vulnerabilities may exist in large institutions that may have software implementations across a multitude of services, including legacy systems. The disclosed embodiments enable efficiency improvements and conservation of resources in addressing such vulnerabilities. In some embodiments, such institutions may involve financial institutions or banks that handle sensitive or protected data, such as financial information for clients.

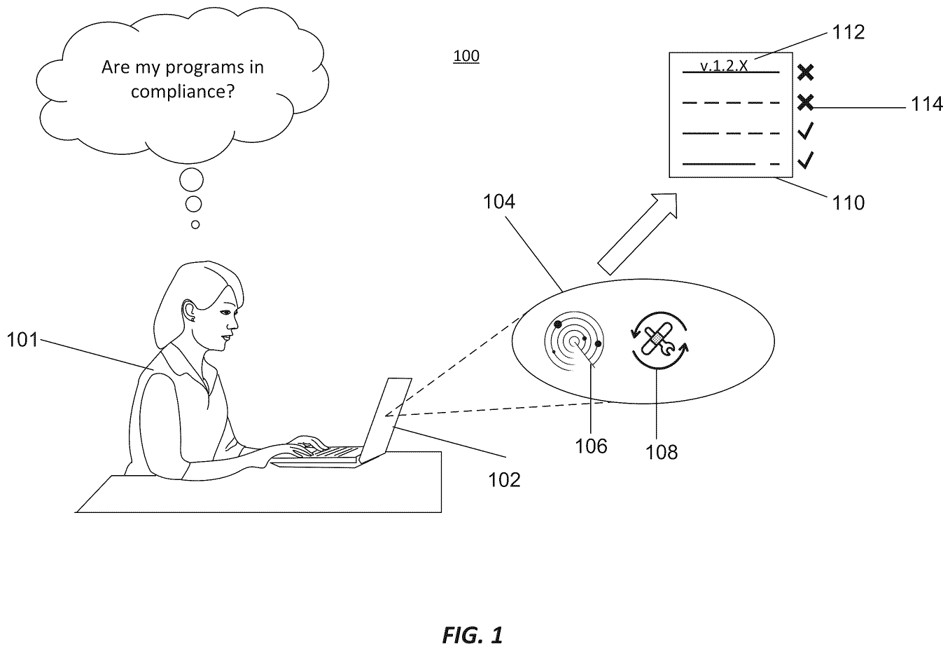

FIG. 1 is an illustration of an exemplary system for resolving compliance checks, consistent with disclosed embodiments. System 100 may enable improved maintenance of software to adhere to compliance requirements and prevent or mitigate vulnerabilities. For example, conventional systems may be inefficient in maintaining compliant code for institutions having large numbers of software storage locations for many different programs or applications. Such conventional systems often include developers executing manual updates to each program or application. System 100 may provide improvements to maintaining compliant software by enabling efficient automation of determining whether software is in compliance and updating software accordingly. In some embodiments, system 100 may include device 102, which may be any computing device, including a laptop, desktop, tablet, or mobile phone. In some embodiments, device 102 may be operated by user 101. For example, user 101 may be any individual involved in software development, including engineers, developers, designers, or project managers. Device 102 may be utilized in determining if a software service is in compliance. For example, user 101, may be a developer aiming to determine if certain software is in compliance. User 101 may use device 102. Determining whether a software service is in compliance may be done by checking if a software service is updated or if updates to the software service may be available, as well as checking if there are vulnerabilities in the software service. System 100 may assist in generating requests to check on the compliance of software, such as by generating requests to check a database for available updates. In some embodiments, system 100 may involve scanning module 104. Scanning module 104 may involve retrieving information corresponding to software or a software service, such as program 106 or application 108. Retrieving information may involve accessing, obtaining, or receiving information, including through application programming interface (API) calls (e.g., an API call to a database or repository). In some embodiments, system 100 may involve determining a version value by scanning the repository 110. Repository 110 may be associated with program 106 or application 108. For example, repository 110 may store files and code corresponding to program 106, and repository 110 may be scanned by analyzing the files and code it stores. In some embodiments, system 100 may retrieve a version value to determine if program 106 is in compliance with standards for the program (e.g., an institution may have a standard requiring that the program is the most up-to-date version and that the program has to be updated within a certain time frame). For example, version value 112 from repository 110 may indicate the current version of program 106, and version value 112 may be used to identify if newer versions of program 106 have been released. For example, if version value 112 does not correspond to the most up-to-date version of program 106, program 106 may not be in compliance, and should be upgraded. In an example, users (such as user 101) may be prevented from using program 106 if the program is determined to not be in compliance. In some embodiments, system 100 may scan repository 110 to identify one or more security vulnerabilities 114. For example, system 100 may determine if security vulnerabilities 114 exist in repository 110 and modify the code accordingly, such as by adding or deleting code to remove or mitigate the vulnerability. It will be appreciated that the disclosed embodiments, such as scanning module 104, may provide efficiency improvements to maintaining compliant code by enabling automated detection of vulnerabilities, thereby reducing the need for manual compliance checks.

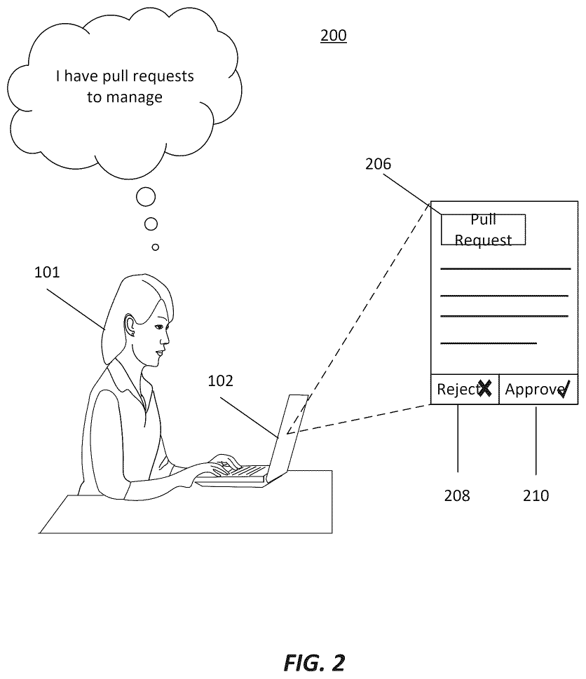

FIG. 2 is an illustration of a system for deploying software to resolve vulnerabilities, consistent with disclosed embodiments. System 200 may include device 102, which may be used to generate and/or review pull requests. In some embodiments, generating a pull request may involve triggering the pull request. Triggering a pull request may involve sending or transmitting the pull request to a repository. In some embodiments, generating a pull request may involve notifying a third party. For example, upon generation of a pull request, a developer or developer team may be made aware that there are pending changes to be implemented into the repository, such as changes to code or files stored in the repository for a software service. For example, pull request 206 may include modifications to code including additions and/or deletions of code. As an example, system 200 may notify user 101 via computing device 102 that a pull request 206 has been generated. In some embodiments, reviewing pull request 206 may involve approving or rejecting the pull request. For example, user 101 may reject 208 or approve 210 the pull request. A pull request may refer to a proposal to change to code and/or files. For example, approving pull request 206 may result in code being implemented into the repository by merging the code from a feature or development branch to the main branch. In another example, rejecting or denying pull request 206 may prevent the proposed changes from being implemented into the repository. In some embodiments, a pull request may be automatically approved. For example, system 200 may approve pull requests 206 and merge the updated code into the repository. It will be appreciated that disclosed embodiments improve system speeds and reduce backlogs in implementing or updating code. For example, disclosed embodiments determine whether repositories are in compliance, rather than having a developer or user manually check individual repositories. As such, it will be appreciated that versions of software not in compliance and requiring updates may have pull requests generated faster, reducing the amount of time that vulnerabilities such as bugs exist in the software service, thereby improving the functioning of a computer. In some embodiments, upon approval of pull request 206, the updated code may be automatically deployed. For example, a template may be generated (e.g., as part of a continuous integration pipeline) based on approval of the pull request 206 for the updated code and a container may be built from the template to be deployed (e.g., as part of a continuous deployment pipeline) to a production environment for an end-user.

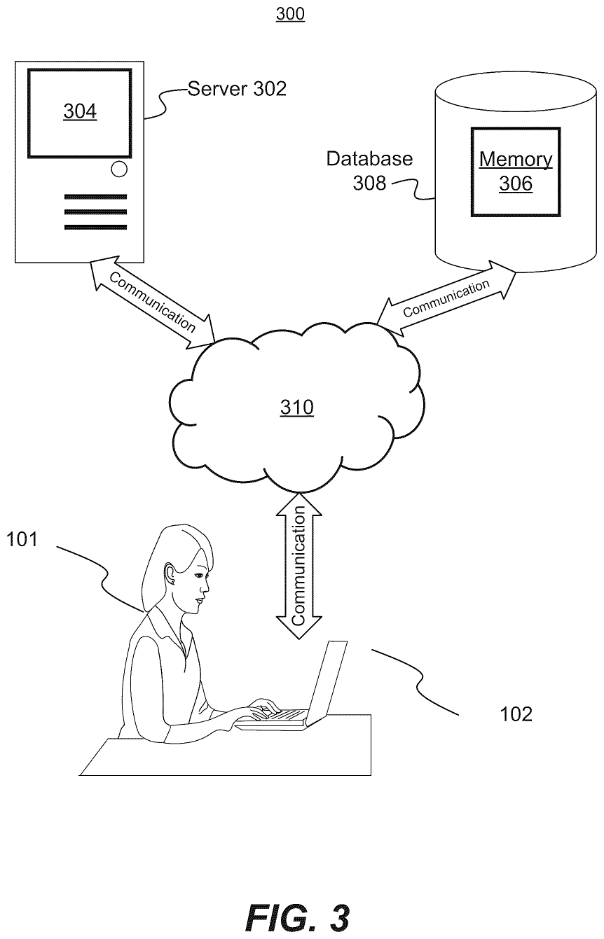

FIG. 3 illustrates an exemplary electronic communication system 300, consistent with disclosed embodiments. As shown in FIG. 3, System 300 may include a network 310 and may include device 102. System 300 may also include a server 302, which may include a processor 304. In an example, processor 304 may reside in server 302. In some embodiments, processor 304 may be a processor of device 102 and reside separately from server 301. System 300 may also include a database 308, which may include a memory 306. In an example, database 308 may reside in memory 306. In another example, database 308 may reside in server 302. User 101 may interact with device 102, including providing inputs to device 102 (e.g., through a keyboard, mouse, microphone, or user interface) and receiving outputs from device 102 (e.g., audio and/or visual information). In system 300, server 302 and database 308 may communicate with each other via network 310, server 302 and device 102 may communicate with each other over network 310, and device 102 and database 308 may communicate with each other over network 310.

Consistent with disclosed embodiments, “at least one processor” (e.g., 304) may constitute any physical device or group of devices having electric circuitry that performs a logic operation on an input or inputs. For example, the at least one processor 304 may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor (e.g., 304) may include more than one processor. Each processor (e.g., 304) may have a similar construction or the processors (e.g., 304) may be of differing constructions that are electrically connected or disconnected from each other. For example, the processors (e.g., 304) may be separate circuits or integrated in a single circuit. When more than one processor (e.g., 304) is used, the processors (e.g., 304) may be configured to operate independently or collaboratively, and may be co-located or located remotely from each other. The processors (e.g., 304) may be coupled electrically, magnetically, optically, acoustically, mechanically or by other means that permit them to interact. Processor 304 may take the form of, but is not limited to, a microprocessor, embedded processor, or the like, or may be integrated in a system on a chip (SoC). Furthermore, according to some embodiments, processor 304 may be from the family of processors manufactured by Intel®, AMD®, Qualcomm®, Apple®, NVIDIA®, or the like. The processor 304 may also be based on the ARM architecture, a mobile processor, or a graphics processing unit, etc.

The instructions executed by at least one processor (e.g., 304) may, for example, be pre-loaded into a memory (e.g., 306), integrated with or embedded into the controller or may be stored in a separate memory. Memory (e.g., 306) may include a Random Access Memory (RAM), a Read-Only Memory (ROM), a hard disk, an optical disk, a magnetic medium, a flash memory, other permanent, fixed, or volatile memory, or any other mechanism capable of storing instructions. As used herein, a memory (e.g., 306), refers to any type of physical memory on which information or data readable by at least one processor may be stored. Examples of memory include Random Access Memory (RAM), Read-Only Memory (ROM), volatile memory, non-volatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same.

The terms “memory” (e.g., 306) and “computer-readable storage medium” may refer to multiple structures, such as a plurality of memories or computer-readable storage mediums located within an input unit or at a remote location. Additionally, one or more computer-readable storage mediums may be utilized in implementing a computer-implemented method. The memory (e.g., 306) may include one or more separate storage devices collocated or disbursed, capable of storing data structures, instructions, or any other data. The memory (e.g., 306) may further include a memory portion containing instructions for the processor to execute. The memory (e.g., 306) may also be used as a working scratch pad for the processors (e.g., 304) or as a temporary storage. Accordingly, the term computer-readable storage medium should be understood to include tangible items and exclude carrier waves and transient signals.

Consistent with the present disclosure, disclosed embodiments may involve a network (e.g., 310). A network (e.g., 310) may constitute any type of physical or wireless computer networking arrangement used to exchange data between, for example, device 102, server 302, and/or database 308. For example, a network (e.g., 310) may be the Internet, a private data network, a virtual private network using a public network, a Wi-Fi network, a LAN or WAN network, a combination of one or more of the foregoing, and/or other suitable connections that may enable information exchange among various components of the system (e.g., 300). In some embodiments, a network (e.g., 310) may include one or more physical links used to exchange data, such as Ethernet, coaxial cables, twisted pair cables, fiber optics, or any other suitable physical medium for exchanging data. A network (e.g., 310) may also include a public switched telephone network (“PSTN”) and/or a wireless cellular network. A network (e.g., 310) may be a secured network or unsecured network. In other embodiments, one or more components of the system (e.g., 300) may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between for example, device 102, server 302, and/or database 308.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system (e.g., 300, a component of memory 306) or a remote computing component (e.g., a cloud-based data structure). Data in the data structure may be stored in contiguous or non-contiguous memory. Moreover, a data structure, as used herein, does not require information to be co-located. It may be distributed across multiple servers (e.g., 302), for example, that may be owned or operated by the same or different entities. Thus, the term “data structure” as used herein in the singular is inclusive of plural data structures.

Certain embodiments disclosed herein may include a processor (e.g.) configured to perform methods that may include triggering an action in response to an input. The input may be from a user action. A trigger may include an input of a data item that is recognized by at least one processor (e.g., 304) that brings about another action.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor (e.g., 304). It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor (e.g., 304), cause the at least one processor (e.g., 304) to perform a method. Non-transitory computer readable mediums may be any medium capable of storing data in any memory (e.g., 306) in a way that may be read by any computing device with a processor (e.g., 304) to carry out methods or any other instructions stored in the memory (e.g., 306). The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”) (e.g., 304), a memory (e.g., 306), and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor (e.g., 304) is explicitly shown. In addition, various other peripheral units may be connected to the computer platform such as an additional data storage unit and a printing unit. Furthermore, a non-transitory computer readable medium may be any computer readable medium except for a transitory propagating signal.

Processor 304 may run computer applications. Applications may be mobile computer programs configured to run on mobile phones or tablet computers. Applications may also be computer programs configured to run on laptop computers or desktop computers. Computer applications may be computer software packages designed to carry out specific tasks. Some applications may be front end applications that interact directly with a computer or mobile device user. Processor 304 included in device 102 may, for example, run front end applications. Back-end applications may be applications that support the front-end applications and interact with the front-end applications. A front-end application may call the back-end application to process data or to retrieve or access data. Processor 304 included in server 302 may, for example, run back-end applications.

Disclosed embodiments may involve systems and methods for resolving vulnerabilities, compliance checks, and updates. Compliance checks may include verifying that components of a network or system meet certain standards, conform to regulations, or adhere to policies. For example, compliance checks may inspect or examine files, programs, applications, or databases to determine observance or agreement of rules or best practices. In some embodiments, compliance checks may involve determining whether file characteristics, code, or metadata follow or comply with a standard. Standards may refer to guidelines for developing and/or maintaining software, as described herein. Standards may involve legal, industry, or organizational standards (e.g., standards for maintaining code specific to an institution). For example, a standard may include updating a software service for a financial institution's transaction management platform within one week of identifying a vulnerability with the software service. In another example, a standard may include upgrading a software service handling storage of sensitive data for a financial institution in accordance with privacy regulations.

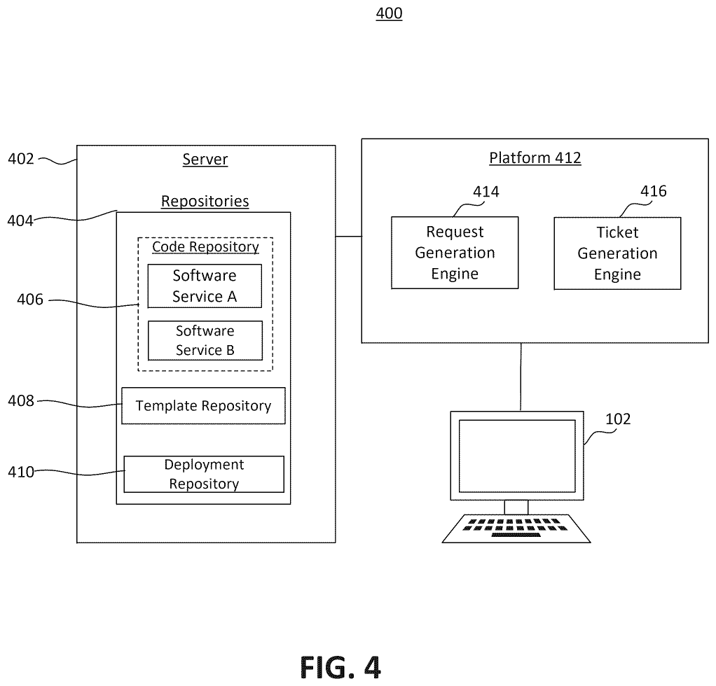

FIG. 4 illustrates a block diagram of a system 400 for software management, consistent with embodiments of the present disclosure. In some embodiments, system 400 may include server 402. For example, server 402 may include or be separate from server 302, as referenced in FIG. 3. System 400 may include platform 412. Platform 412 may include to tools and/or infrastructure for managing and deploying software. As described herein, deploying software may involve the development, testing, packaging, and release of software (e.g., releasing an operational version to an end-user or to a production environment). In some embodiments, platform 412 may communicate with network 310. Platform 412 may assist in deploying software from server 402. In some embodiments, server 402 may contain repositories 404. In some embodiments, repositories 404 may include repository 110. Repositories 404 may refer to a version control system. A repository may include storage locations for software development, including code, documentation, tests, scripts, and files. Repositories may allow management and organization of software projects, including deployed software and software in development. Repositories may include folders, directories, or data structures storing version information, metadata, source code, or code archives. Repositories may contain or track changes to a codebase, such as by keeping record of additions, deletions, or modifications to code for a program. For example, repositories may store different versions of a program. In some embodiments, a repository may include branches for various copies or various versions of the programs it contains. In some embodiments, repositories may be remote, such as repositories stored in a cloud server, or local, such as repositories stored on the same system or network as the corresponding application. For example, repositories may include GITHUB, BITBUCKET, GITLAB, ASSEMBLA, SOURCEFORGE, and LAUNCHPAD. Repositories 404 may include one or more repositories, such as different types of repositories or repositories configured to contain different types of information.

In some embodiments, repositories 404 may include code repository 406. In some embodiments, a repository, such as code repository 406, may be associated with a software service. A software service may refer to any type of service delivered through software, including programs or applications. In some embodiments, software services may refer to modular components of a service-oriented architecture (e.g. different software services may provide different roles). Software services may include API services, web services, application services, database services, and cloud-based services. Software services may include internal tools (e.g., internal to a business) as well as external programs (e.g., a consumer or client-facing application). For example, software services may include programs used for developing system architectures or frameworks. In some embodiments, software services may include programs used to develop applications or software, such as Java. In some embodiments, software services may include microservices. Microservices may focus on a single task or a small bucket of tasks. For example, for a software service corresponding to tools for developing a banking application, microservices may include payment transaction services, fraud detection services, and account display services. In some embodiments, code repository 406 may include multiple repositories, such as different repositories corresponding to different software services (e.g., a first code repository may contain code for software service A and a second code repository may contain code for software service B). For example, software service A may be a software service for front-end functionalities, and software service B may be a software service for back-end functionalities. Code repository 406 may contain information corresponding to a software service, including code (e.g., source code), configuration files, and version information for the software service. A configuration file may be a file for defining parameters, preferences, or initial settings for a software service. Configuration files may provide information about the behavior, environment, function, and/or execution of a software service. Code repository 406 may also involve various development branches for different software services. For example, software service A may be stored in a code repository having a master branch, a development branch, and a testing branch for software service A. In some embodiments, the code repositories and/or different development branches may be associated with a version of the software service. Code repository 406 may also include documentation files describing version information, installation guidelines, and/or operating guidelines for a software service, such as a README file. For example, a README file may be a text document providing an overview of a software service.

Some disclosed embodiments involve mitigating vulnerabilities for code stored in code repository 406. As described herein, code for software services may have various vulnerabilities, which may refer to threats, service disruptions, security incidents, bugs, glitches, and/or errors of the software service. Vulnerabilities may also include compliance vulnerabilities, such as when a software service fails to meet or satisfy certain criteria including regulations, best practices, or standards for the service. For example, vulnerabilities may include software services that are not up to date or in compliance with various policies. It will be recognized that software services that are not updated can present vulnerabilities and security issues, which may have been resolved in later versions of the software. Thereby, maintaining compliant software, such as by ensuring that the version of the software in use is within a certain range of the most updated software, can assist in reducing such vulnerabilities. For example, system 400 may involve a third-party software service having code for a version 1.1 stored in code repository 406. The third-party software service may have a compliant, updated version 1.2 released to address vulnerabilities in version 1.1, and platform 412 may access the updated version 1.2 (e.g., through API calls or from a database). The disclosed embodiments may involve determining whether any repositories in repositories 404 are utilizing the third-party software service and identifying whether the versions in repositories 404 are compliant (e.g., matches updated version 1.2) or not (e.g., has version 1.1 or otherwise does not meet version 1.2).

In some embodiments, determining whether repositories are in compliance may involve automatically scanning repositories 404. Scanning the repositories may involve parsing, examining, or analysing repositories and the information or data contained within them, such as in repositories 404. For example, a program may look for version values in different file locations in the repository and identifying the most recent version. Additionally, or alternatively, system 400 may receive and/or generate requests to mitigate vulnerabilities. For example, platform 412 may include a request generation engine 414. Request generation engine 414 may generate requests to determine whether certain repositories of repositories 404 are compliant (e.g., a request may be generated to determine whether a specific software service is updated). Request generation engine 414 may specify a request to update one or more software services. For example, a generated request may include code changes to multiple software services in code repository 406. Request generation engine 414 may receive requests from device 102. For example, request generation engine 414 may receive requests from device 102 (e.g., a user may request an update to software service A in code repository 406). In some embodiments, request generation engine 414 may automatically generate requests. For example, a third-party may release an update to software service B, and platform 412 may interact with a database associated with the third-party over network 310 to view code changes in the update. In some embodiments, request generation engine 414 may continually and/or periodically (e.g., every hour, every day, or every week) communicate with the third-party database to determine if an update is available by comparing the code or the version of the software in third-party database to the code or the version of the software in code repository 406. In some embodiments, system 400 may include a ticket generation engine 416. Ticket generation engine 416 may be any tool configured for assisting in project management or issue tracking for software development. For example, a request to update a software service from request generation engine 414 may trigger a ticket from ticket generation engine 416. The generated tickets may refer to any documented record of a task, work item, event, or request, such as a tracking token (e.g., a JIRA ticket). In some embodiments, ticket generation engine 416 may communicate the generated ticket with computing device 418. For example, computing device 418 may be a computer for a developer for system 400.

In some embodiments, repositories 404 may include template repository 408. Template repository 408 may be a repository for storing templates. Templates may refer to files or executable code (e.g., code containing instructions). Templates may be executable files for running software or creating containers (e.g., executable packages of software). Executable code may be software in a form that can be run on a computer. Executable code may cause a computer to perform tasks as instructed by the code. For example, executable code may be directly executed by the central processing unit. Executable code may also refer to machine language, executables, executable programs, or executable files. In some embodiments, files comprising executable code may include static files with executable code having instructions to create a container on a computing system. Templates may include various elements for running a software service, such as an operating system, code, dependencies, libraries, or files. Some examples of templates may be read-only. Templates may include one or more layers providing different instructions or modifications for building a container. In some embodiments, templates may refer to images, such as Docker images. For example, a template may refer to a Docker image built from one or more Dockerfiles. In some embodiments, templates may be generated based on code for software services. For example, system 400 may use code in code repository 406 to generate a template stored in template repository 408.

In some embodiments, repositories 404 may include deployment repository 410. A deployment repository may refer to a repository for storing or managing artifacts and configuration files for deploying software. Deployment repository 410 may store configuration files, templates, binaries, or metadata. For example, deployment repository 410 may store software service templates that are ready for deployment.

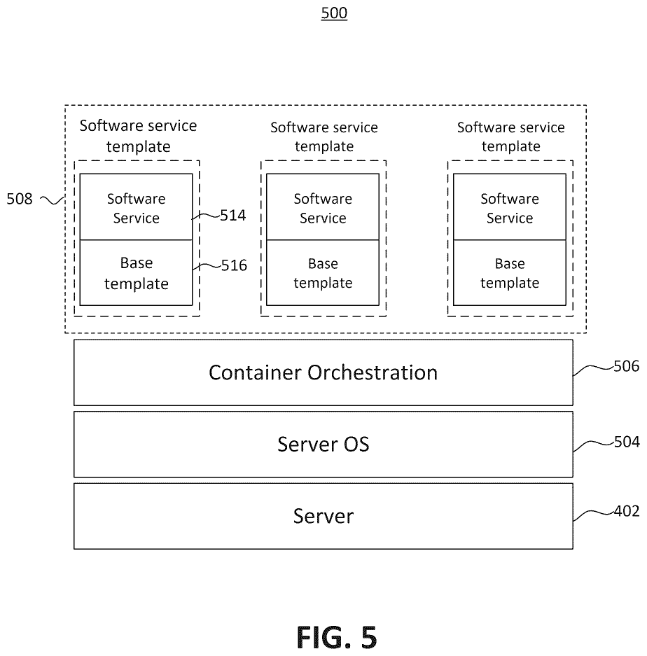

FIG. 5 illustrates a diagram 500 of a containerized software service implementation, consistent with embodiments of the present disclosure. In some embodiments, server 402 may be a computer connected to a network to execute software service templates 508, which may include one or more software service templates. Server operating system 504 may run on server 402, and container orchestration platform 506 may run on server operating system 504. Container orchestration platform 506 may refer to a system for managing containerized software and replicating containerized software. As described herein, containerized software may refer to executable packages of software, such as a unit including code for a software service as well as the dependencies for the software service. For example, a container may refer to a Docker container. Container orchestration platform 506 may automate the networking and deployment of containers, including managing resource allocation across containers and balancing network traffic to containers. For example, container orchestration platform 506 may deploy a template of software service templates 508 by generating the container based on a template (e.g., image). Software service templates 508 may include one or more templates, as described herein. The templates may include a base template 516 and code for a software service 514. The base template 516 (e.g., base image) may be a foundational layer for the template and may include an operating system or runtime environment. Code for software service 514 may be built on base template 516. For example, source code for a software service 514 for architecture functionality may be built on base template 516. Container orchestration platform 506 may allocate resources, including memory, storage, and processing, between containers, as well as deploying containers according to resource requirements and availability. Container orchestration platform 506 may also manage configuration settings, provide security features to protect containerized software, and enable communication between containers. In some embodiments, container orchestration platform 506 may enable scaling by automatically adjusting which containers may be running or the number of containers running to match a given demand. Examples of container orchestration platforms may include OPENSHIFT, KUBERNETES, and DOCKER.

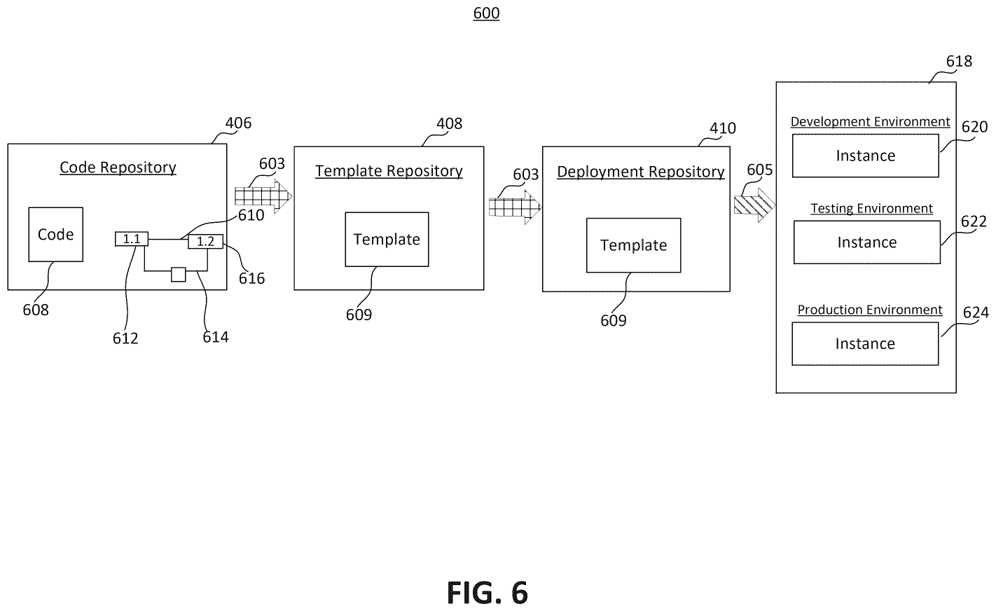

FIG. 6 illustrates a block diagram of a process 600 for building and deploying containerized software, consistent with embodiments of the present disclosure. As described herein, deploying containerized software may involve one or more repositories, such as code repository 406, template repository 408, and deployment repository 410. Code repository 406 may include files and/or source code for various software services. For example, code repository 406 may include code 608 corresponding to a software service, such as when code repository 406 stores configuration files having code 608. For example, code 608 may be source code for a software service. Code repository 406 may include different versions of code for the software service, such as a version 612 of code 608. For example, code repository 406 may include different branches corresponding to different versions of the code, such as a main branch 610 (e.g., a master branch, primary branch, release branch, or production branch), as well as various feature branches. Feature branches may be separate branches from main branch 610 that are used for development of different features or software releases. In an example, version 612 may be an earlier version of code 608 for a software service, and version 612 may need to be updated to address a vulnerability of code 608, as described herein. Feature branch 614 may be branched off main branch 610 to update code 608, such as by making a copy of code 608 to a separate branch from main branch 610. Feature branch 614 may include changes made to version 612 of code 608 to address the vulnerability. The updates to code 608 may be merged back to main branch 610, thereby creating an updated version 616 of code 608. For example, a pull request may be generated for branch 614 to request integrating the changes to 608 into code repository 406. Merging feature branch 614 into main branch 610 may involve accepting the changes involved in the pull request, thereby integrating the updates to code 608 into code repository 406 and creating updated version 616 of code 608. In some embodiments, the integration of the code changes to code repository 406 and/or creation of updated version 616 may be automatic (e.g., executed in real time) upon acceptance of the pull request. In some embodiments, upon acceptance of pull request or upon creation of updated version 616, feature branch 614 may be closed (e.g., deleted from memory and/or removed from code repository 406).

In some embodiments, process 600 may involve generating a template 609 based on the updated code. For example, template 609 may include a base template 516 and code for a software service 514 Template 609 may be generated based on the updated version 616 of code 608 for a software service. In some embodiments, building templates may involve a continuous integration pipeline, such as continuous integration (CI) pipeline 603. CI pipeline 603 may be a workflow for automating the delivery of code changes or new code releases to a shared repository. CI pipeline 603 may involve building and testing of the updated version 616 of code 608 (e.g., to ensure the code mitigates vulnerabilities or achieves an intended task). CI pipeline 603 may deliver the updated version 616 of code 608 from code repository 406 to template repository 408. For example, CI pipeline 603 may involve building a template 609 based on the updated version 616 of code 608 (e.g., creating an image based on a configuration file). CI pipeline 603 may involve deploying or publishing the template to a template repository 408. For example, template repository 408 may store template 609.

In some embodiments, CI pipeline 603 may also involve updating a deployment repository 410 by storing template 609 in the deployment repository 410. For example, CI pipeline 603 may deliver template 609 from template repository 408 to deployment repository 410. As described herein, deployment repository 410 may include configuration files and the template 609. For example, when template 609 is saved to template repository 408, CI pipeline 603 may update deployment repository 410 to store template 609. As such, deployment repository 410 may maintain the latest version of templates and corresponding configurations.

In some embodiments, a continuous deployment (CD) pipeline 605 may deliver template 609 from deployment repository 410 to container orchestration platform 618. Changes to templates in deployment repository 410 may trigger the deployment of the template to container orchestration platform 618. For example, if an update is made to template 609 in deployment repository 410, continuous deployment (CD) pipeline 605 may use configurations in deployment repository 410 to deploy template 609 to container orchestration platform 618. For example, deploying template 609 may involve building a container based on template 609. In some embodiments, CD pipeline 605 may generate a container, and container orchestration platform 618 may generate a container instance (e.g., a running instance of the container). Additionally, or alternatively, container orchestration platform 618 may deploy a container instance by pulling from deployment repository 410. Container orchestration platform 618 may deploy instances to various environments. For example, container orchestration platform 618 may deploy an instance to a development environment 620. The development environment may be for developing code, such as an environment on a developer's local machine. Additionally, or alternatively, container orchestration platform 618 may deploy an instance to a testing environment 622. For example, the testing environment may simulate a production environment, and may include various tests for functionality, bugs, performance, security, and/or quality of software. Additionally, or alternatively, container orchestration platform 618 may deploy an instance to a production environment 624. For example, production environment 624 may be where the software service is available to end-users, such as users within an institution and/or external clients.

It will be recognized that different software services, as described herein, may have differing frequencies for compliance checks. For example, some third-party software services that are continuously updated and have new versions periodically released (e.g., Angular, for front-end development) may be monitored to update the corresponding software for the software service version stored in a code repository, such as code repository 406. In another example, software services may be updated based on a specific request, such as a request made by a developer to address a vulnerability for a specific software service. It will be appreciated that the disclosed embodiments provide automation of software service updates to enable software services to resolve vulnerabilities and maintain compliance.

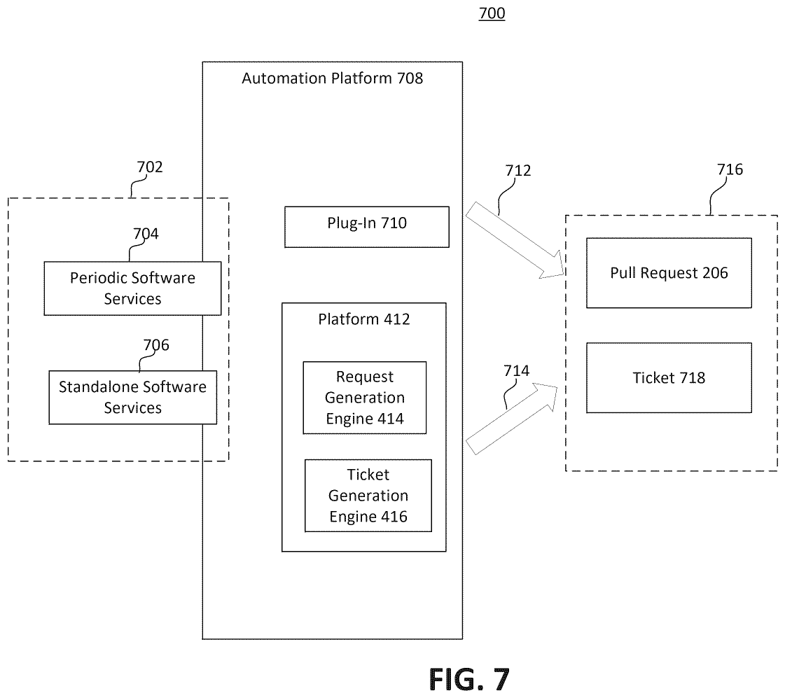

FIG. 7 illustrates a system 700 for automatically resolving compliance checks and updates, consistent with embodiments of the present disclosure. System 700 may include automation platform 708. Automation platform 708 may be a platform or system configured to automatically update software services, such as software services 702. In some embodiments, automation platform 708 may include platform 412 or be in electronic communication with platform 412 (e.g., over network 310). In an example, software services 702 may be stored in repositories 404 (e.g., in code repository 406). In some embodiments, automation platform 708 may electronically communicate with server 402 over network 310.

Software services 702 may include different categories of software services, including periodic software services 704 and standalone software services 706. Periodic software services 704 may include software services corresponding to a periodic automation label, which may refer to services that are continuously maintained or periodically updated, such as every day, week, or month, as non-limiting examples. For example, a third-party software service that receives updates every week may have a periodic automation label. In another example, software services that receive updates at irregular frequencies or intervals may have a periodic automation label. In some embodiments, periodic software services 704 may include a software service for front-end architecture.

Additionally, or alternatively, a periodic automation label may correspond to vulnerabilities that may be monitored at various intervals, including both regular and irregular intervals. For example, periodic software services 704 may include software services scanned every week to identify malware vulnerabilities in the code and/or to identify updates that resolve such vulnerabilities. Standalone software services 706 may include software services corresponding to a standalone automation label, which may be a category of services that may receive updates on demand or based on request (e.g., a developer request). For example, request generation engine 414 may generate requests to update a software service in standalone software services 706 (e.g., based on receiving information that an update is available). In another example, request generation engine 414 may receive a request from a user, such as user 101 through a device, such as device 102, as described with respect to FIG. 1 to resolve a vulnerability in a specific software service. In some embodiments, software service 706 may correspond to a standalone automation label. In some embodiments, a software service may have both a standalone automation label and a periodic automation label.

In some embodiments, system 700 may include a plug-in 710. Plug-in 710 may be a software component providing a set of changes to be applied to a codebase, such as to code or files within a repository. In some embodiments, plug-in 710 may be an executable file, program, or application that may encapsulate one or more changes to repositories for software services 702. Plug-in 710 may be configured to assist in updating software and implementing changes. For example, plug-in 710 may describe a set of changes to be made to code for periodic software service 704, and plug-in 710 may be distributed to repositories storing code for software service 704 to generate a pull request for the changes. In another example, plug-in 710 may receive code and/or files from repositories for software services 702. It will be appreciated that by automatically monitoring for updates (e.g., with automation platform 708), the disclosed embodiments provide reduced cost, time, and resources compared to having developers continually check for updates.

In some embodiments, plug-in 710 may be generated by request generation engine 414. For periodic requests, request generation engine 414 may generate plug-ins at various intervals. For example, request generation engine 414 may automatically create plug-in 710 based on the determination (e.g., by automation platform 708) that an update is available to periodic software service 704. In another example, request generation engine 414 may automatically generate plug-in 710 at periods corresponding to periodic software service 704 (e.g., every week). In some embodiments, plug-in 710 may have a recurring execution 712. Recurring execution 712 may refer to processing and completing updates to periodic software service 704 with plug-in 710, such as by instantiating plug-in 710 and distributing plug-in 710. For example, instantiating plug-in 710 may refer to generating the plug-in with the code changes it is tasked with. Distributing plug-in 710 may refer to distributing plug-in 710 to communicate the proposed changes to repositories of software service 704. Recurring execution 712 may occur at various intervals as described herein to generate outputs 716. For example, recurring execution 712 may occur weekly to generate a pull request 206 for a repository corresponding to periodic software service 704. Pull-request 206 may capture the changes proposed by plug-in 710. The pull request may be communicated to a developer (e.g., user 101), and the developer may determine whether to accept pull request 206 to implement the changes to the repository, as described herein. Recurring execution 712 may also generate a ticket 718. As described herein, ticket 718 may be generated by ticket generation engine 416 and can be used to track the progress or status of updates and/or pull requests.

In some embodiments, plug-in 710 may be generated for updates to standalone software service 706. For standalone requests, request generation engine 414 may generate plug-ins to resolve a specific vulnerability or update a specific software service. For example, request generation engine 414 may generate plug-in 710 based on a request from a developer (e.g., user 101). In another example, request generation engine 414 may automatically generate plug-in 710 based on identifying a vulnerability, such as identifying a high-priority security vulnerability in standalone software service 706. In some embodiments, plug-in 710 may have a standalone execution 714. Standalone execution 714 may refer to processing and completing updates to standalone software service 706 with plug-in 710, such as by instantiating plug-in 710 and distributing plug-in 710, as described herein. Standalone execution 714 may occur on-demand, such as when changes are requested by a developer. For example, standalone execution 714 may generate a pull request 206 for a repository corresponding to standalone software service 706. Pull request 206 may capture the changes proposed by plug-in 710, and a developer may determine whether to accept pull request 206 to implement the changes to the repository, as described herein. Standalone execution 714 may also generate a ticket 718.

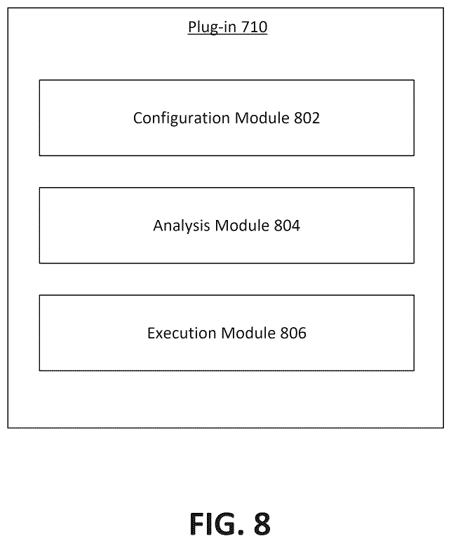

FIG. 8 illustrates a diagram of a plug-in 710 for updating software services, consistent with embodiments of the present disclosure. Plug-in 710 may include configuration module 802. Configuration module 802 may refer to code and/or executable files for determining how plug-in 710 operates. Configuration module 802 may include information corresponding to the specific update or reason for the instantiation of plug-in 710, such as why plug-in 710 was generated by request generation engine 414, or what updates plug-in 710 should create.

In some embodiments, configuration module 802 may include code and/or configuration files for determining which software services and repositories plug-in 710 should be deployed to. In other embodiments, configuration module 802 may receive information such as code, software version, configuration files, and/or README files from a repository (e.g., code repository 406). Plug-in 710 may include analysis module 804. Analysis module 804 may be configured to scan repositories, such as scanning code and/or files, as described herein. For example, analysis module 804 may scan repository 406 to determine the location of information within the repository. Analysis module 804 may also scan the repository to identify code or files to update, such as specific lines of code that may be modified according to configuration module 802. Plug-in 710 may include execution module 806. Execution module 806 may be configured to make modifications to the repository the plug-in 710 is deployed to. In some embodiments, execution module 806 may include the updated code to be integrated into the repository. Recurring execution 712 and/or standalone execution 714 may involve generating pull request 206, and pull request 206 may represent the proposed modifications to code in repositories for software services 702 according to the updated code in execution module 806. For example, recurring execution 712 and/or standalone execution 714 may generate pull request 206 for a repository, and user 101 may review pull request 206. If user 101 approves pull request 206, the repository may implement the modifications provided by execution module 806.

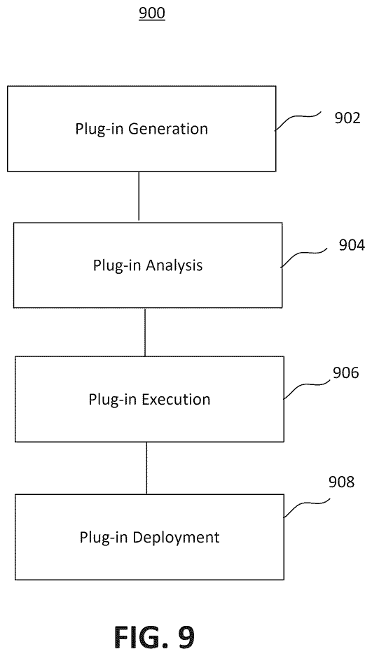

FIG. 9 illustrates a process 900 for updating code with a plug-in, consistent with embodiments of the present disclosure. In some embodiments, process 900 may be involved in recurring execution 712 and/or standalone execution 714. In some embodiments, plug-ins referenced in process 900 may include plug-in 710.

In some embodiments, process 900 may include a step 902 of generation a plug-in. For example, step 902 may involve instantiating plug-in 710 with automation platform 708, such as generating a plug-in based on a request from request generation engine 414. Step 902 may involve determining configuration information for plug-in 710. For example, step 902 may include receiving and/or generating information with configuration module 802 corresponding to the type of update, the update information, and repository location plug-in 710 should be deployed to.

In some embodiments, process 900 may include a step 904 of plug-in analysis. Step 904 may involve analyzing repositories with analysis module 804. Step 904 may involve scanning information for software services, as described herein.

In some embodiments, process 900 may include a step 906 of plug-in execution. For example, step 906 may involve updating software services by generating an updated version of the code (e.g., including the updates identified by configuration module 802). Step 906 may involve proposing the updates on a feature branch, such as feature branch 614 for a software service. Additionally, step 906 may involve generating a pull request 206.

In some embodiments, process 900 may involve a step 908 of plug-in deployment. For example, step 908 may involve deploying plug-in 710 to various repositories (e.g., as identified by configuration module 802) to deliver the pull request so the updates may be reviewed (e.g., by user 101).

The disclosed embodiments may involve various examples or use cases of updating code with a plug-in. Such examples may be executed with or in accordance to process 900.

In an example of process 900, a plug-in may be utilized to install libraries or configurations across several repositories. For example, repositories for a software service for configuring or setting up software architectures or frameworks may include inner APIs (which may refer to internal APIs, such as APIs within internal development system) as well as outer APIs (e.g., end-user APIs, APIs for user interfaces, or client or third-party APIs external to development system). For example, step 904 may involve a plug-in, such as plug-in 710 scanning a repository to detect code for inner APIs, outer APIs, and any configuration files corresponding to the outer or inner APIs. In some embodiments, the plug-in 710 may detect configuration files (e.g., .yaml files or other text files storing configurable parameters) containing links to inner APIs to ensure the software service can connect to the inner API. Plug-in 710 may then execute by proposing updates to the repository, as described in step 906. For example, plug-in 710 may reduce compute overhead by removing synthetic monitoring configurations to streamline the deployment of the service and/or disabling configurations for functional testing or performance testing to enable more rapid deployment, conserve memory within the repository, and conserve processing resources during container generation and operation. Plug-in 710 may update the code corresponding to the topology of the software service. For example, the topology may refer to connections or arrangements and interactions between components, software services, dependencies, and/or containers. Updating the topology may involve updating any dependency links and port mappings for the software service. such as replacing links pointing to inner APIs with internal service links in the configuration file. In some embodiments, plug-in 710 may update the repository according to a deployment repository or container orchestration platform. For example, plug-in 710 may update the repository to have a folder or file structure that matches or mirrors the structure of the deployment repository for the software service. Plug-in 710 may also set up unique keys for configurations in a container orchestration platform. For example, for software services corresponding to sensitive data, plug-in 710 may generate separate configuration keys specific to separate environments to ensure containers are deployed to the correct environment and prevent containers from being deployed to the wrong location.

In another example of process 900, plug-in 710 may be configured for replicating software service files from a remote repository (e.g., a repository not on server 402). In some embodiments, step 902 and step 904 may involve receiving a location or identification of a source remote repository and one or more target files located in the repository. Step 906 may involve cloning (e.g., copying) the information from the source repository to the destination repository.

In another embodiment, plug-in 710 may clean configuration and initialization data from certain repositories. For example, step 902 may involve configuring plug-in 710 to update a repository for a software service including an initialization configuration folder storing temporary build files and cache data (e.g., a. gradle folder). Plug-in 710 may detect if the initialization configuration folder exists in the repository in step 904. Upon detecting the initialization configuration folder, in step 906, the plug-in may propose updates to the repository to remove or delete the initialization configuration folder. In some embodiments, in step 904, plug-in 710 may scan for an exclusion file in the repository which manages files, code, or directories that should be ignored by a version control system. For example, upon detecting an exclusion file, such as a. gitignore file, the plug-in may update the exclusion file to exclude the initialization configuration folder (e.g., such as a. gradle folder). It will be appreciated that by deleting the initialization configuration file, plug-in 710 may conserve memory by removing build and cache data specific to local environments (e.g., which may not be useful to other environments the software service is deployed to), as well as reducing build errors due to the initialization configuration file.

In another example of process 900, step 902 may involve generating a plug-in corresponding to updates for connection timeouts for software services. During attempts to connect different services (e.g., to connect one software service to another or to connect to a client API), excessive wait times may hinder network communications by slowing down other connections. In step 904, plug-in 710 may scan software services, such as repositories containing code for network architecture, for a configuration file. In step 906, plug-in 710 may execute by proposing updates to the configuration file with a connection timeout property, such as 500 milliseconds or other short time frame to reduce the strain on the network by cancelling the connection attempt after the time frame has been exceeded.

In another example of process 900, a plug-in may update URLs within repositories. For example, plug-in 710 may scan repositories for the identifiers, pointers, or names of software services that may be deprecated or updated and change such references to new references. Plug-in 710 may also propose updates to the repository to the latest version of the software service. In some embodiments, plug-in 710 may search for files with specific extensions, such as .yml, .yaml, java, groovy, js, or json files.

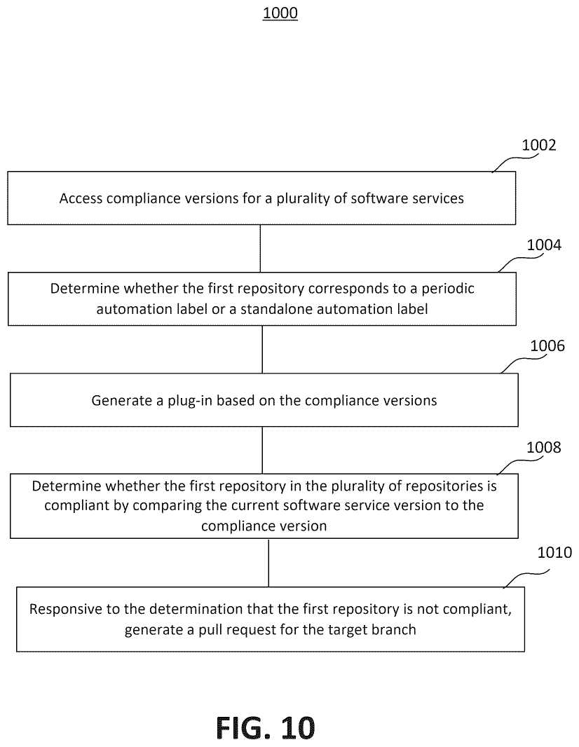

FIG. 10 illustrates a process 1000 for automatically resolving compliance checks and updates, consistent with embodiments of the present disclosure. At step 1002, a processor may access compliance versions for a plurality of software services corresponding to a plurality of repositories. A compliance version may refer to the latest software iteration of a given software service and/or may refer to the version of software already deployed. The compliance version may have already been checked for compliance with one or more software standards associated with the compliance checks and updates. In some embodiments, a first repository in the plurality of repositories has a current software service version and a target branch. The current software service version may refer to the software version being modified and that may need to be checked for compliance and updates, according to disclosed embodiments. The target branch may refer to a main or master software branch, or may refer to another active software branch to which the current software service version is to be merged. Merging the current software service version to the target branch may be an act of committing or deploying software code or may be a request to commit or deploy the code. Merging the current software service version to the target branch may constitute a request for manual or automatic review of the current software service version, such as quality assurance review.

At step 1004, the processor may determine whether the first repository corresponds to a periodic automation label or a standalone automation label, as described herein. At step 1006, the processor may generate a plug-in based on the compliance versions, wherein the plug-in comprises update code, as described herein. The generated plug-in may correspond to plug-in 710 and generating the plug-in may be performed as in step 902, as described with respect to FIGS. 7 and 9. Update code may refer to code to be merged into the target branch. The update code may include code from the current software service version or may include code that has been updated from the current software service version. In some embodiments, the update from the current software service version may be based on compliance with one or more software standards.

At step 1008, the processor may determine whether the first repository in the plurality of repositories is compliant by comparing the current software service version to the compliance version. In some embodiments, the comparison may include a line-by-line comparison that may present to a user differences between the current software service version and the compliance version. In some embodiments, the comparison may include comparing the current software service version to one or more software standards with which the compliance version was previously found to comply, to determine whether the current software service version complies with the software standards. In some embodiments, the comparison may include determining the effect of functionality described in the current software service version and the compliance version, to determine whether the current software service version and the compliance version perform the same function. In such embodiments, unit tests may be run on the current software service version and the compliance version to ensure equivalent functionality. Such embodiments may correspond to attempts to refactor the compliance version using the current software service version. In alternate embodiments, the compliance version and current software service version may perform different functions. For example, the current software service version may have been developed to add features to the compliance version.

At step 1010, the processor may, responsive to the determination that the first repository is not compliant, generate a pull request for the target branch. In some embodiments, the pull request may include a modification to the first repository based on the update code. The pull request may need to be approved to merge the update code into the target branch. Merging the update code into the target branch may act to deploy the update code based on a confirmation that the update code complies with one or more software standards. In some embodiments, approval of the pull request may include manual and/or automatic checks for compliance with one or more software standards and may involve checking the update code against one or more unit tests and/or one or more other forms of software tests. Approval of the pull request may include manual or automatic review of comments and/or functionality performed by the update code before the code is merged into the target branch.

In some embodiments, the processor may further determine whether the first repository corresponds to a periodic automation label or a standalone automation label. Correspondence to a periodic automation label or a standalone automation label may influence the manual and/or automatic tests and checks performed on the update code according to disclosed embodiments.

In some embodiments, the processor may further generate a ticket that includes a periodic automation ticket based on the determination that the first repository corresponds to a periodic automation. In some embodiments, the processor may generate a ticket that includes a standalone automation ticket based on the determination that the first repository corresponds to a standalone automation. The generated ticket may be configured to request that an employee manually review the update code for compliance with one or more software standards or may request that an employee confirm that an automatic review of the update code has been performed. In some embodiments, the generated ticket may be configured to request modifications to the update code.

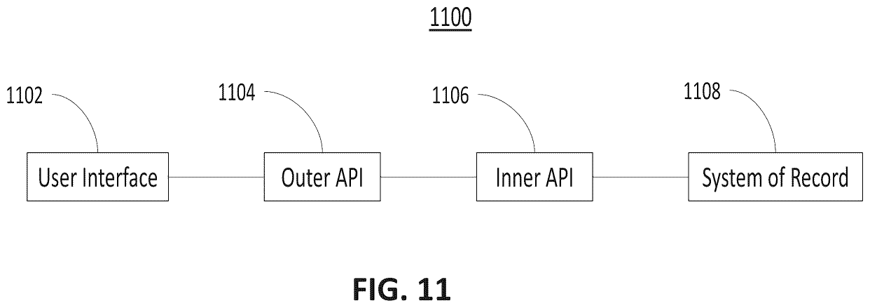

FIG. 11 illustrates an exemplary deployment container structure 1100, consistent with disclosed embodiments. In some embodiments, deployment container structure 1100 may include one or more user interfaces (UIs) 1102, one or more outer APIs 1104, one or more inner APIs 1106, and one or more systems of record 1108. UI 1102, outer API 1104, inner API 1106, and system of record 1108 may be configured in a standalone container orchestration platform setup, such that each of UI 1102, outer API 1104, inner API 1106, and system of record 1108 are deployed on a separate pod. Alternatively, UI 1102, outer API 1104, inner API 1106, and system of record 1108 may be configured in a single pod container orchestration platform setup, such that UI 1102, outer API 1104, inner API 1106, and system of record 1108 are deployed together onto a single pod. Pods may be individualized deployable units in a deployment architecture, and may share storage and network resources, as well as a specification directed to running elements within the pod. Configuring UI 1102, outer API 1104, inner API 1106, and system of record 1108 in a single pod container orchestration platform setup may be convenient or necessary when UI 1102, outer API 1104, inner API 1106, and system of record 1108 are tightly coupled or otherwise interconnected.

In some embodiments, UI 1102 may be developed under an architecture designed to facilitate the creation of micro applications within a platform 412, as described with respect to FIG. 4. The architecture may provide consistent user interface elements across exemplary UIs 1102 and may host one or more UIs 1102 for facilitated display to a user, such as user 101.

UI 1102 may be in electronic communication with an outer API 1104. In some embodiments of the present disclosure, a given outer API 1104 may be configured so that it may only be consumed by its corresponding UI 1102, such that there is a one-to-one relationship between outer API 1104 and UI 1102. In some embodiments, outer API 1104 may be responsible for converting back-end code to a front-end user experience. Outer API 1104 may be configured to orchestrate calls to one or more inner APIs 1106, filter data from an inner API 1106 to fit a channel experience and a channel form factor, and transform data from an inner API JSON format to a format that may be consumed by a front-end, such as UI 1102. In some embodiments, the one-to-one relationship between UI 1102 and outer API 1104 may cause each outer API 1104 to be unique to each user experience, such as UI 1102. Each outer UI 1104 may thus be tightly coupled with UI 1102 and, in some embodiments, cannot be re-used between multiple experiences.

One or more inner APIs 1106 may be in electronic communication with outer API 1104, forming a one-to-many relationship. An inner API 1106 may also be consumed by multiple outer APIs 1104. Inner API 1106 may be designed using a banking industry architecture network (BIAN) object model (BOM) to model its inputs and outputs.

Inner API 1106 may be in electronic communication with a system of record (SOR) 1108. SOR 1108 may be an information storage system operating as the single authoritative data source for a given set of data. In some embodiments, outer API 1104 may not be permitted to directly consume SOR 1108 data, and must thus access SOR 1108 data only through an inner API 1106. In some embodiments, inner API 1106 acts as the single API for SOR 1108 allowing access to SOR 1108 data, and a single inner API 1106 may be in electronic communication with a single SOR 1108. In some embodiments, inner API 1106 functions only to abstract functionality from SOR 1108 to allow outer API 1104 to access SOR 1108 data. In some embodiments, inner API 1106 ensures loose coupling between UI 1102 and SOR 1108 to maintain application performance and an enhanced user experience for user 101.

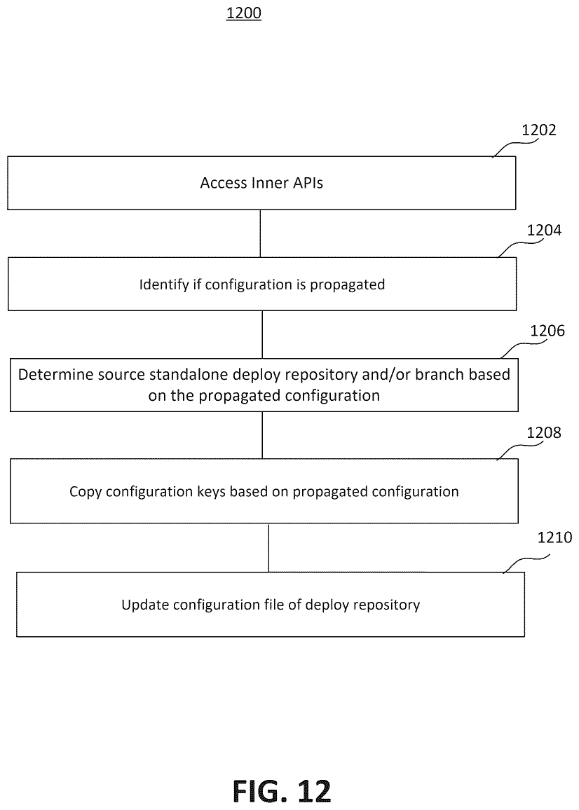

FIG. 12 illustrates a process 1200 for distributing configurations, consistent with embodiments of the present disclosure. Process 1200 may be configured to propagate standalone architectural service configuration changes across applications that deploy the architectural service. In some embodiments, process 1200 may be configured to allow single pod deployment and updates to single pod deployments as described herein. Process 1200 may be configured to deploy a repository associated with inner API 1106, as described herein, and, in some embodiments, this deployment may be performed through a single pod on multiple deployments. In some embodiments, the deployment must coordinate configurations centralized in a repository and propagated through compliance automation tools described herein.

Process 1200 may be configured to migrate applications from a standalone deploy configuration, as described herein, to a single pod configuration, as disclosed herein. Process 1200 may configure an existing deploy repository and obtain components and configuration associated with an inner API such as inner API 1106. Process 1200 may be configured to set up an application using architecture standards that may reference one or more inner APIs such as inner API 1106. In some embodiments, the application may be associated with one or more code repositories and one or more deploy repositories.

At step 1202, process 1200 may access one or more inner APIs, which may correspond to inner API 1106 described herein. Inner APIs accessed at step 1202 may be used by a target single pod deployment repository, such as deployment repository 410, as described herein. As described consistent with disclosed embodiments, accessing an inner API may be necessary to access data associated with one or more systems of records, such as SOR 1108. As such, multiple inner APIs may be searched for and accessed at step 1202 if data associated with multiple systems of record are accessed.

At step 1204, process 1200 may identify whether a configuration must be propagated. Propagating a configuration may refer to creating copies of the configuration to be disseminated across services that may access the configuration, so that each service accessing the configuration is accessing the same configuration. The step 1204 of identifying whether a configuration must be propagated may be performed by process 1200 as to each inner API accessed at step 1202.

At step 1206, process 1200 may find a source standalone deploy repository and/or branch. The step 1206 of finding a source standalone deploy repository and/or branch may be performed by process 1200 as to each configuration identified as needing to be propagated at step 1204. In some embodiments, each identified configuration may be associated with a unique source standalone deploy repository and/or branch. In other embodiments, multiple identified configurations may be associated with a given source standalone deploy repository and/or branch.

At step 1208, process 1200 may copy any configuration keys associated with configurations identified as needing to be propagated at step 1204. In some embodiments, each identified configuration may be associated with a single configuration key. In some embodiments, one or more identified configurations may have more than one configuration key or no configuration key. Copying configuration keys may be performed as needed based on a configuration associated with process 1200. A configuration key may be a string corresponding to a configuration parameter associated with a configuration identified as needing to be propagated at step 1204 and may be used to establish global settings for a database or to set configuration parameters for a given collection of software. The configuration may be a bucket configuration associated with storing resources in a bucket or other software object storage container.

At step 1210, process 1200 may update a configuration file associated with a deploy repository. Updating the configuration file may ensure compatibility with one or more new configurations. The update may correspond to each configuration identified as needing to be propagated in step 1204. In some embodiments, the configuration file may be a. yaml file.

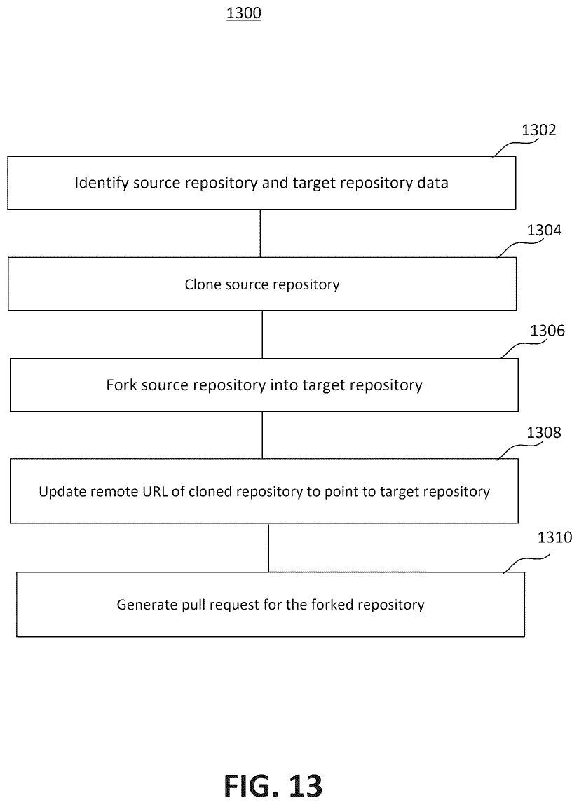

FIG. 13 illustrates a process 1300 for migrating repositories, consistent with embodiments of the present disclosure. Process 1300 may be configured to migrate repositories by creating a fork to maintain a historical repository while adding additional configurations to be deployed in connection with a new repository.

At step 1302, process 1300 may identify source repository and target repository names and locations for a migration of repositories. In some embodiments, source repository and target repository may be directed to related or different purposes and may be designed to perform similar or different functions.

At step 1304, process 1300 may clone the source repository, which may involve copying one or more code elements from the source repository. At step 1304, process 1300 may apply changes to the cloned source repository that may involve changes in configuration files. Configuration files changed at step 1304 may include Jenkingsfile, settings. gradle, and grade. properties. In some embodiments, the changes applied to the cloned source repository may affect the way the pipeline interprets the repository. The impact on pipeline interpretation may ensure that the changed cloned repository is compliant with software standards associated with the target repository. In some embodiments the cloned repository may require a full directory refactor to adapt to the target repository's conventions. The full directory refactor may include changes to code to comply with one or more software standards. The full directory refactor may be designed to keep code functionality consistent between the code before the refactor and the code after the refactor.

At step 1306, process 1300 may fork the source repository into the target repository. Forking the source repository into the target repository may act to maintain the historical repository while permitting the addition of additional configurations to be deployed with the new repository.

At step 1308, process 1300 may update the remote URL of the cloned repository to point to the target repository. Step 1308 may cause the cloned repository to be run on the target repository while the historical repository is maintained. Updating the remote URL may cause the cloned repository code to be called via reference to the target repository.

At step 1310, process 1300 may generate a pull request for the forked repository. Generating the pull request may involve pushing the changed cloned repository to a main or master branch, which may deploy the code or request review of the code to be deployed as described herein. The target repository may implement code associated with the changed cloned repository after the pull request.

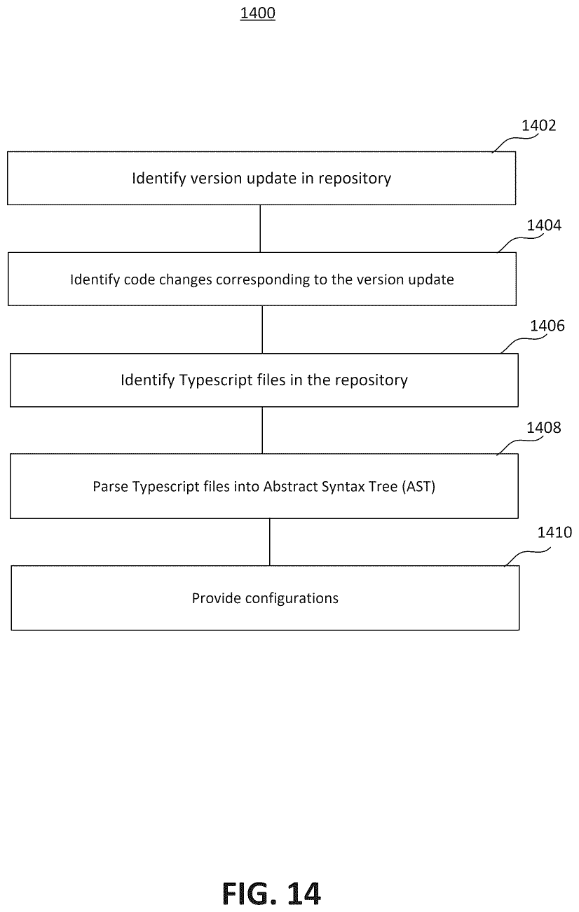

FIG. 14 illustrates a process 1400 for analyzing code, consistent with embodiments of the present disclosure. Process 1400 may analyze an existing application to identify tailored code updates required for major version upgrades to architectures and frameworks. The application may contain an Abstract Syntax Tree (AST) with source code, which may be Typescript code, that may need to be parsed as part of the analysis. The AST may be a tree representation of source code for the existing application that may represent the syntactic structure of the code. The AST may abstract away syntactic details from the source code to form the syntax tree, and may contain structural or content-related details. The AST may not explicitly represent groupings in the code and may denote expressions like if-then statements through the tree's structure, such as by including a node with multiple branches. In some embodiments, a parse tree may be used in the place of the AST. In such embodiments, the parse tree may be built by a parser during compiling of the source code if the source code is compiled, and additional information may be added to the tree during subsequent processing. Major version updates of architectures and frameworks may involve code change due to breaking changes in the architecture or framework. Process 1400 may allow for an in-depth analysis of existing code, which may reduce manual work after version upgrades by permitting more rapid locating of required code changes.

At step 1402, process 1400 may identify a version update in a repository. The repository may be a package. json repository. Identifying a version update may involve an automated lookup process to search for version updates to a repository. Identifying a version update may involve an automatic step of flagging code updates in a repository during pull requests.

At step 1404, process 1400 may identify code changes associated with the version update identified at step 1402. Identifying code changes may involve an automated comparison between code versions to identify changes from one version to another version. Identifying code changes may involve flagging code changes as part of a pull request through either a manual or automated flagging process.

At step 1406, process 1400 may identify Typescript files in the repository. Identifying Typescript files may involve iterating each Typescript file in the repository to determine whether any code changes exist that should or may be applied. Determining whether any code changes exist may involve a manual or automated check for code changes as described herein. Other file types besides Typescript files may be iterated to determine whether any code changes exist that need to be applied in accordance with embodiments described herein.

At step 1408, process 1400 may parse one or more source code files into an AST or similar tree. In some embodiments, the source code files may be Typescript files. In some embodiments, each source code file in the repository may be parsed into an AST to find specific nodes containing code changes that need to be applied and locate the corresponding position of those nodes in the file. The nodes may be import declarations, class declarations, or decorators, among other code structures. In an exemplary embodiment, a node is located that may require import replacements due to deprecation of one or more structures, class declaration renaming, or deleting obsolete properties.

At step 1410, process 1400 may provide configurations associated with running the code. Providing configurations may include supplementing the version and code updates with any configuration that may be necessary to run the code. In some embodiments, the configuration is necessary based on code standards associated with the repository. In some embodiments, the configuration may be provided by one or more quality assurance reviewers and/or may be provided by an automated review process associated with the code update.

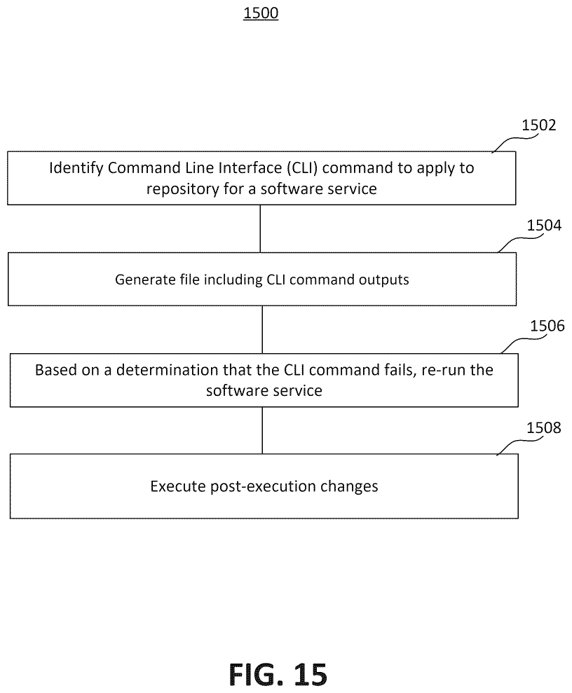

FIG. 15 illustrates a process 1500 for automating command line interface (CLI) commands, consistent with embodiments of the present disclosure. Process 1500 may run a chain of existing CLI commands to log, troubleshoot, and supplement the existing CLI commands as necessary. By running commands, logging, troubleshooting, and supplementing, process 1500 may act to automate or simulate manual tasks previously necessary to run the CLI commands, improving workflow and reducing developer time used to run the CLI commands. In some embodiments, frameworks or architectures may provide CLI commands unique to the given framework or architecture that may need to be run to upgrade or modify one or more existing repositories. Running the CLI commands may require manual work that consumes developer time. Automation through process 1500 may bundle the CLI commands, which was impossible through previous manual operations, which may avoid the need for developers to be idle during wait time between CLI command executions, troubleshooting known issues, and supplementing the updates with one or more configurations that may be personalized or may be specific to the framework or architecture.

At step 1502, process 1500 may identify one or more CLI commands to apply to a repository for a software service. Identifying the one or more CLI commands to apply may involve identifying CLI commands that must be applied to code associated with a framework or architecture and may involve identifying CLI commands unique to the framework or architecture, as well as identifying CLI commands that may not be unique to the framework or architecture. In some embodiments, the identified CLI commands may be grouped for execution.

After one or more CLI commands are identified, the identified CLI commands may be executed in sequence or in parallel. In some embodiments, executing the identified CLI commands may require ensuring compliance with any configuration change required as a preparation before execution of the command. In some embodiments, executing the identified CLI commands may involve ensuring that the one or more identified CLI commands comply with one or more software standards.

At step 1504, process 1500 may generate one or more files to include the identified CLI commands. In some embodiments, the one or more files may be a log file for auditing and troubleshooting. At step 1506, process 1500 may determine whether one or more identified and executed CLI commands has failed execution. At step 1506, process 1500 may re-run failed CLI commands, which may restore the application's status. Failure of an executed CLI command may be based on a formatting error or a processing error and may require modifications to one or more code elements or one or more of the identified CLI commands to ensure that the identified CLI command does not fail when executed.

At step 1508, process 1500 may execute post-execution changes. The post-execution changes may be changes to a repository associated with the framework or architecture. The post-execution changes may involve changes to the source code within the framework or architecture and/or may involve changes to the identified CLI commands. The post-execution changes may involve the introduction of additional CLI commands and may include re-running process 1500, as needed.

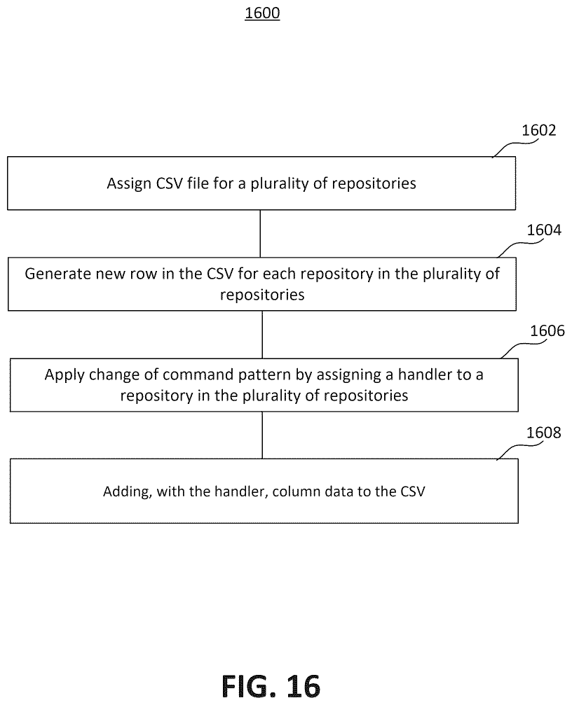

FIG. 16 illustrates a process 1600 for chain of command repository reporting, consistent with embodiments of the present disclosure. In some large organizations, some information may be difficult to standardize across processes associated with the large organization. As an example, specialized tools may offer partial views of the status of a repository but may not provide analysis or views of the full range of repositories associated with functionality in a large organization. Automation may allow for a scan of many or all repositories associated with the large organization and may allow for the collection of metadata that represents a full view of the health of the many or all repositories. Process 1600 may include iteration over a large quantity of repositories that may be associated with a large organization. Process 1600 may obtain information about one or more common properties between one or more repositories and may obtain information about the topology and versions of one or more repositories. Process 1600 may aggregate the obtained information into a comprehensive report associated with one or more repositories that may be associated with a large organization.

At step 1602, process 1600 may assign a unique report file for a plurality of repositories. In some embodiments, the plurality of repositories may include every repository that process 1600 will scan to iterate over the repositories. In some embodiments, the unique report file may be a. csv file and/or may be split across multiple files. In some embodiments, a different unique report file may be assigned for each request associated with a set of repositories, or a duplicative unique report file may be assigned for duplicative sets of repositories. In the former case, the assigned unique report file may include metadata characteristics such as the timing of the assignment of the unique report file to the set of repositories.

At step 1604, process 1600 may generate a new row in the unique report file for each repository in the plurality of repositories. The new row may include report data unique to each repository or may include data duplicated between repositories. The new row may include metadata associated with one or more repositories or each repository in the plurality of repositories. An absence of data corresponding to an entry in the new row may cause process 1600 to stop running, may cause introduction of an error, or may be ignored. Handling of the absence of data corresponding to an entry may vary based on the type, structure, quality, quantity, and/or importance of data.

At step 1606, process 1600 may apply a change of command pattern to an analysis of the report file. In some embodiments, the change of command pattern involves assigning a handler to one or more repositories in the plurality of repositories. The handler may be a routine, function, or method that may be specialized in a type of data or focused on specialized tasks. The handler may be configured to run a partial analysis on each repository to which it is assigned. In this way one handler may run a subset of analysis associated with a report file, while a group of handlers together may run all of the analysis associated with a report file. A group of handlers may thus allow for a full view of the health of many or all repositories in a large organization. In some embodiments, more than one handler may be assigned to a given repository, and/or a single handler may be assigned to more than one repository, potentially forming a one-to-one, one-to-many, many-to-one, or many-to-many relationship between handlers and repositories.

At step 1608, process 1600 may add one or more columns of data to the report file. The one or more columns may include data or metadata associated with one or more repositories and may include data or metadata unique to one or more repositories. Process 1600 may call a next handler for a given repository, set of repositories, or next repository at step 1608, which may allow for scalability in a comprehensive report that may be generated from the unique report file. In some embodiments, one or more handlers may run in parallel, or each handler may run in series. In some embodiments, handlers may be associated with unique columns associated with the unique report file to ensure that no two handlers attempt to write data to the same location in the report file.

In some embodiments, one or more handlers may skip execution if existing metadata indicates that the analysis of the one or more handlers does not apply. Skipping execution of one or more handlers based on existing metadata may allow handlers to auto-manage the context of an application and their applicability, which may reduce developer workload associated with managing handlers. Skipping execution of one or more handlers may have been based on a determination that was impossible with manual determinations of which handlers to run, either because metadata analysis associated with skipping execution would have been impossible in the human mind or because metadata analysis at scale would have been impossible or practically infeasible due to size, time, and calculation difficulty limitations associated with metadata analysis. Skipping execution of one or more handlers may significantly increase execution capacity of one or more processors associated with handler execution by limiting unnecessary code execution, saving memory, and reducing expenditure of resources such as time.

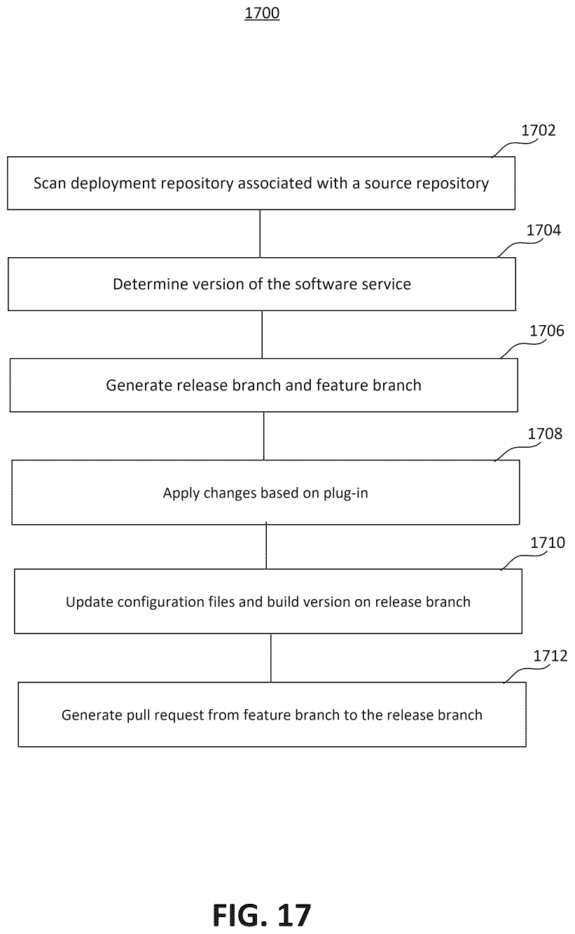

FIG. 17 illustrates a process 1700 for updating release branches, consistent with embodiments of the present disclosure. Process 1700 may help expedite changes to production, which may be valuable when existing changes associated with a master branch cannot be promoted to higher environments. The ability to automate changes that may include automated updates may reduce wait time and/or may reduce the need for developer time spent implementing and/or approving automated changes that may not impact code functionality. Process 1700 may build a release branch according to one or more development requirements associated with a framework or architecture, which may include manual our automated changes to source code associated with the release branch.

At step 1702, process 1700 may scan one or more deployment repositories associated with one or more source repositories. The one or more deployment repositories may correspond to deployment repository 410, and the one or more source repositories may correspond to code repository 406, as described with respect to FIG. 4. In some embodiments, a single deployment repository is associated with a given source repository. At step 1704, a deployment repository associated with each source repository may be scanned to determine the version of the application for which quality assurance (QA) checks are requested.

At step 1706, process 1700 may generate a release branch and a feature branch associated with the deployment repository. In some embodiments, the release branch may be generated from a commit used during the QA process. In some embodiments, the feature branch may be created to apply one or more changes associated with the source repository.

At step 1708, process 1700 may apply the one or more changes associated with the source repository. In some embodiments, application of the changes may be based on a plug-in, such as plug-in 710 generated as in step 902 and/or step 1006, or may be an unrelated plug-in uniquely associated with the one or more changes. At step 1710, process 1700 may apply changes to a configuration file such as a Hintfile or a Jenkinsfile. In some embodiments, applying changes to the configuration file enables a version build on a release branch, which may be necessary to deploy one or more code changes. Step 1710 may involve creating the version build on the release branch.

At step 1712, process 1700 may generate a pull request from the feature branch into the created release branch. As described herein, generating a pull request may cause process 1700 to request further review of code associated with the feature branch or may automatically merge the feature branch into the created release branch. In some embodiments, merging the feature branch into the created release branch may deploy code associated with the feature branch, which may cause the code to run for one or more service users. In some embodiments, merging the feature branch into the created release branch may create a new version and update the changes to the QA environment, which may skip one or more review steps associated with deploying source code. Further QA review of the new version may be required according to some embodiments.

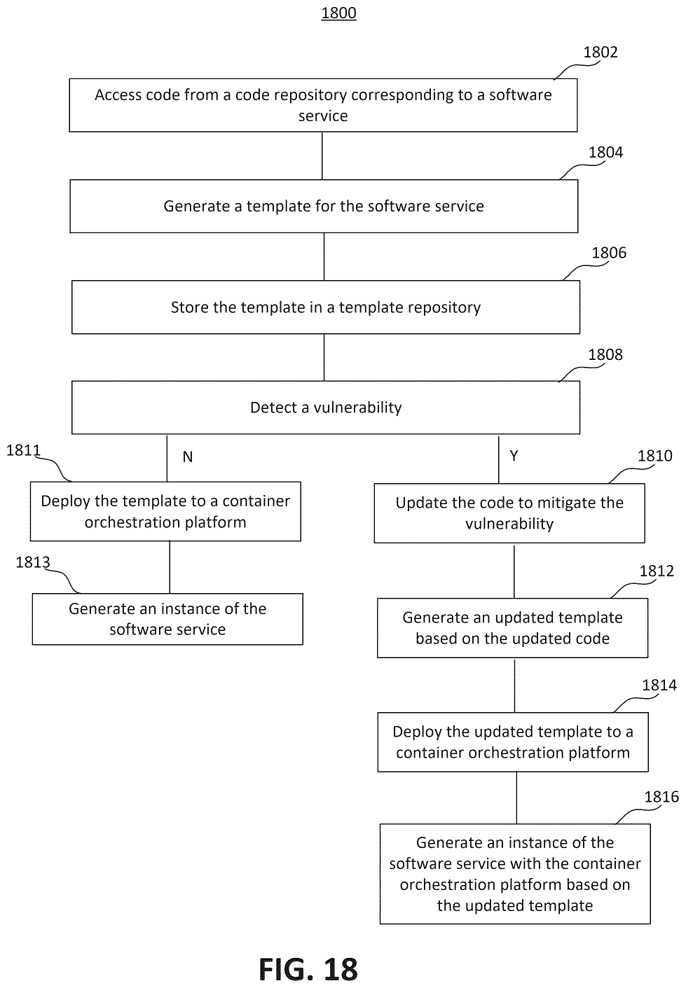

FIG. 18 illustrates a diagram of a process 1800 for building and deploying containerized software services during software development, consistent with embodiments of the present disclosure. In some embodiments, process 1800 may include a step 1802 of accessing code from a code repository corresponding to a software service. Accessing may involve retrieving, acquiring, or obtaining information or data. For example, code may be accessed from a code repository storing code for a software service. In some embodiments, the code repository may include one or more configuration files that may have code for the software service.

In some embodiments, process 1800 may include a step 1804 of generating a template for the software service based on the code. Generating a template (e.g., image) may involve compiling the code for the software service and creating an executable file. In some embodiments, step 1804 may involve a continuous integration (CI) pipeline. For example, a CI pipeline may automatically compile the code and create a template based on the code. The template may be generated by building the code for the software service onto a base template.

In some embodiments, process 1800 may include a step 1806 of storing the template in a template repository. Storing the template may involve publishing the template to a template repository, such as any repository manager configured to store templates (e.g., images), binaries, artifacts, or code dependencies. In some embodiments, a CI pipeline may automatically store, deploy, or upload the template to a template repository.

In some embodiments, process 1800 may include a step 1808 of detecting a vulnerability. In some embodiments, step 1808 may involve detecting a vulnerability in the code (e.g., code for a software service). Vulnerabilities may be detected by comparing version values of code or templates. For example, process 1800 may detect a vulnerability by identifying a version of a software service stored in a repository and comparing the version to later versions of the software service that may be available. In another example, detecting a vulnerability may involve identifying threats such as potential malware, viruses, bugs, glitches, flaws, exploits, and/or crashes for the software service.

In some embodiments, in response to detecting a vulnerability, process 1800 may proceed to step 1810 of updating the code to mitigate the vulnerability. For example, code for a software service may be updated to the latest version (e.g., a version which resolves the vulnerability). In some embodiments, updating code may involve merging code (e.g., generating and/or accepting a pull request). Additionally, or alternatively, step 1810 may involve updating configuration files in a code repository.

In some embodiments, process 1800 may involve a step 1812 of generating an updated template based on the updated code in response to detecting a vulnerability in the code. For example, the updated template may be generated by packaging the updated code onto a base template (e.g., base image) or executing the updated code to build the template. Additionally, or alternatively, the updated template may be generated by updating the base template based on configuration files stored in a repository for a software service. In some embodiments, step 1812 may involve a continuous integration (CI) pipeline. For example, the updated template may be stored in a template repository and/or a deployment repository, and the deployment repository may include configuration files.

In some embodiments, process 1800 may involve a step 1814 of deploying the updated template to a container orchestration platform responsive to detecting a vulnerability in the code. Step 1814 may include deploying the updated template from a deployment repository to a container orchestration platform, such as container orchestration platform 618. For example, the updated template may be deployed to the container orchestration platform based on a configuration files stored in the deployment repository. In some examples, step 1814 may involve a continuous deployment (CD) pipeline.

In some embodiments, process 1800 may involve a step 1816 of generating an instance of the software service with the container orchestration platform responsive to detecting a vulnerability in the code. For example, generating an instance may involve building a container for the software service based on the updated template. Step 1816 may involve determining, with the container orchestration platform, various locations to deploy the generated instance, including development, production, and/or testing environments.

In some embodiments, in response to failing to detecting a vulnerability, process 1800 may proceed from step 1808 to step 1811 of deploying the template to a container orchestration platform. Proceeding from step 1808 to step 1811 may involve a continuous deployment (CD) platform, as described herein. For example, step 1811 may involve deploying the template from a template repository (e.g., from step 1806). In some embodiments, process 1800 may involve a step 1813 of generating an instance of the software service with the container orchestration platform based on the template stored in the template repository. For example, the instance may be deployed to a development environment, a testing environment, and/or a production environment, as referenced in FIG. 6.

Embodiments described herein may refer to methods that include various steps. Unless the order is characterized as necessary, the steps of methods described herein may be performed in any order possible to achieve the results of the method. In addition, steps may be removed, or combined with other steps. Steps shown in connection to a method or process described herein may be understood to be sub-steps within another method or process described herein or may otherwise work into another method or process described herein.

What is claimed is:

1.-20. (canceled)

21. A method performed by at least one processor for automatically resolving compliance checks and updates, comprising:
accessing a compliance version for a software service corresponding to a repository, wherein the repository includes a current software service version and a target branch for the software service;
generating a plug-in based on the compliance version, wherein the plug-in comprises an update code and an execution module;
determining if the repository is compliant by comparing the current software service version to the compliance version; and
responsive to the determination that the repository is not compliant, generating a pull request for the target branch to apply the update code using the execution module.

22. The method of claim 21, further comprising:
determining, based on the current software service version, whether the repository corresponds to a periodic automation label or a standalone automation label.

23. The method of claim 22, further comprising:
based on the determination that the repository corresponds to a periodic automation label, generating a periodic automation ticket.

24. The method of claim 22, further comprising:
based on the determination that the repository corresponds to a standalone automation label, generating a standalone automation ticket.

25. The method of claim 21, wherein the plug-in further comprises a configuration module configured to identify the repository and an analysis module configured to scan the repository.

26. The method of claim 21, further comprising updating a configuration file of the software service based on one or more changes to be applied to the repository according to the update code.

27. The method of claim 21, wherein the plug-in is configured to remove a monitoring configuration of the repository.

28. A system comprising:
a memory storing instructions;
a database, in electronic communication with the memory, configured to store information comprising:
a processor, in electronic communication with the database, configured to execute the instructions to perform operations comprising:
accessing a compliance version for a software service corresponding to a repository, wherein the repository includes a current software service version and a target branch for the software service;
generating a plug-in based on the compliance version, wherein the plug-in comprises an update code and an execution module;
determining if the repository is compliant by comparing the current software service version to the compliance version; and
responsive to the determination that the repository is not compliant, generating a pull request for the target branch to apply the update code using the execution module.

29. The system of claim 28, wherein the operations further comprise:
determining, based on the current software service version, whether the repository corresponds to a periodic automation label or a standalone automation label.

30. The system of claim 29, wherein the operations further comprise:
based on the determination that the repository corresponds to a periodic automation label, generating a periodic automation ticket.

31. The system of claim 29, wherein the operations further comprise:
based on the determination that the repository corresponds to a standalone automation label, generating a standalone automation ticket.

32. The system of claim 28, wherein the plug-in further comprises a configuration module configured to identify the repository and an analysis module configured to scan the repository.

33. The system of claim 28, wherein the operations further comprise:
updating a configuration file of the software service based on one or more changes to be applied to the repository according to the update code.

34. The system of claim 28, wherein the plug-in is configured to remove a monitoring configuration of the repository.

35. A non-transitory computer-readable medium including instructions that are executable by one or more processors to perform operations comprising:
accessing a compliance version for a software service corresponding to a repository, wherein the repository includes a current software service version and a target branch for the software service;
generating a plug-in based on the compliance version, wherein the plug-in comprises an update code and an execution module;
determining if the repository is compliant by comparing the current software service version to the compliance version; and
responsive to the determination that the repository is not compliant, generating a pull request for the target branch to apply the update code using the execution module.

36. The non-transitory computer-readable medium of claim 35, wherein the operations further comprise:
determining, based on the current software service version, whether the repository corresponds to a periodic automation label or a standalone automation label.

37. The non-transitory computer-readable medium of claim 36, wherein the operations further comprise:
based on the determination that the repository corresponds to a periodic automation label, generating a periodic automation ticket.

38. The non-transitory computer-readable medium of claim 36, wherein the operations further comprise:
based on the determination that the repository corresponds to a standalone automation label, generating a standalone automation ticket.

39. The non-transitory computer-readable medium of claim 35, wherein the plug-in further comprises a configuration module configured to identify the repository and an analysis module configured to scan the repository.

40. The non-transitory computer-readable medium of claim 36, wherein the operations further comprise: updating a configuration file of the software service based on one or more changes to be applied to the repository according to the update code.
